(19) United States
(12) Patent Application Publication
(10) Pub. No.: US 2002/0150813 A1
(43) Pub. Date: Oct. 17, 2002

(54) Secondary battery

(76) Inventors: Un-Sick Park, Seoul (KR); Young-Bae Song, Suwon-shi (KR)

Correspondence Address: Robert E. Bushnell, Suite 300, 1522 K Street, N.W., Washington, DC, 20005-1202, US

(21) Appl. No.: 10/134,702

(22) Filed: Apr. 30, 2002

Related U.S. Application Data
(63) Continuation-in-part of application No. 09/319,391, filed on Jun. 1, 1999.
Application No. 09/319,391 is a 371 of international application No. PCT/KR98/00082, filed on Apr. 6, 1998.

(30) Foreign Application Priority Data
Nov. 24, 1997 (KR) 97-62414

(51) Int. Cl. H01M 2/12; H01M 2/36

(52) U.S. Cl. 429/56; 429/72; 429/174

(57) ABSTRACT

A secondary battery includes a can into which an electrode assembly is inserted, a cap assembly mounted to an opening of the can; and an electrolyte injection hole formed on at least one of the can and cap assembly, and a safety member to close the electrolyte injection hole. The electrolyte injection hole is formed on a negative portion of the cap assembly or on the can. The safety member is inserted into and welded on the electrolyte injection hole. Also, a secondary battery, includes a can, a cap assembly on an end of the can, an electrolyte injection hole formed on the cap assembly, means for closing the electrolyte injection hole, and a safety member provided on the can, the safety member for reducing pressure inside the can once the pressure inside the can exceeds a predetermined level.

### CROSS REFERENCE TO RELATED APPLICATIONS AND CLAIM FOR PRIORITY

This application is a continuation-in-part application of U.S. application Ser. No. 09/319,391, filed in the U.S. Patent & Trademark Office on Jun. 1, 1999, and of corresponding International Application No. PCT/KR98/00082, filed on Apr. 6, 1998, U.S. application Ser. No. 09/319,391 and International Application No. PCT/KR98/00082, each being incorporated herein by reference, with International Application No. PCT/KR98/00082 not being published under PCT Article 21(2) in English. Also, this application makes reference to, incorporates the same herein, and claims priority and all benefits accruing under 35 U.S.C. §120 from the aforementioned U.S. application Ser. No. 09/319,391, filed on Jun. 1, 1999, entitled SECONDARY BATTERY, and also from the corresponding International Application No. PCT/KR98/00082 filed on Apr. 6, 1998.

Also, this application makes reference to, incorporates the same herein, and claims all benefits accruing under 35 U.S.C. §119 from Korean Application No. 97-62414 earlier filed in the Korean Industrial Property Office on Nov. 24, 1997 and also from International Application No. PCT/KR98/00082, filed on Apr. 6, 1998.

### BACKGROUND OF THE INVENTION

1. Field of the Invention

The present invention relates to a secondary battery and, more particularly, a safety system of a secondary battery which can reduce internal pressure thereof to prevent the explosion of the secondary battery.

2. Description of the Related Art

Generally, a secondary battery is a rechargeable battery such as a nickel-metal hydride battery, a lithium battery or a lithium-ion battery which is widely used in many applications. Such a secondary battery is subject to high internal pressures due to gases generated by chemical reactions when it is discharged and recharged. Though not common, it is possible for the battery to explode as a result of the gases produced.

Therefore, many presently known secondary batteries have a cap assembly provided with a safety valve which can discharge gases through a discharge hole formed on a cap cover so as to reduce the pressure in the batteries when the pressure in the battery is excessively raised.

The lithium-ion battery includes an electrode assembly inserted into a cap. A cap assembly is mounted on an upper end of the can. Electrolyte is injected into the can through an inlet port formed on the cap assembly. Insulating members are disposed between the electrode assembly and the can.

Referring to FIG. 3, there is shown a conventional cap assembly 2. The cap assembly 2 includes a negative portion 4 welded on an upper end of the can, a positive portion 6 disposed on a central portion of the negative portion 4, and an insulating plate 8 disposed between the negative portion 4 and positive portion 6. A rivet 10 penetrates through the negative potion 4 and positive portion 6 and is coupled to the positive electrode of the roll electrode assembly.

In the above described conventional lithium-iron battery, if the pressure within the battery is abruptly increased by the gas generated therein, the battery may explode. Thus, there is provided gas release means in the secondary battery.

That is, safety grooves 12 are formed in the negative portion 4 of the cap assembly 2 through a mechanical process, etching or electroforming process. The safety grooves 12 are broken open when the internal pressure of the battery is increased above a predetermined level, thereby preventing the battery from exploding.

An electrolyte injection hole 14 is formed on the negative portion 4 of the cap assembly 2. After the electrolyte is injected through the hole 14, a plug 16 is snugly fitted into the hole 14 and is then welded to provide a seal.

FIG. 4 shows another example of a conventional cap assembly 2.

In this example, a ball (not shown) is inserted into the injection hole 14 and is then welded to provide a seal.

In the above described conventional cap assembly shown in FIGS. 3 and 4, since the safety grooves and the electrolyte injection hole are formed on the negative portion which is small in size, it is difficult to design and manufacture the same.

In the conventional cap assembly shown in FIG. 4, since the diameter of the injection hole is small, it is difficult to inject electrolyte into the can.

### SUMMARY OF THE INVENTION

Therefore, the present invention has been made in an effort to solve the above described drawbacks of the prior art.

It is an object of the present invention to provide a cap assembly for a secondary battery, in which safety means can precisely operate at a pre-set pressure to prevent the battery from exploding.

It is another object of the present invention to provide a cap assembly in which the safety means can be easily formed, thereby reducing manufacturing costs.

To achieve the above objects, the present invention provides a secondary battery including a can into which an electrode assembly is inserted; a cap assembly mounted to an opening of the can; and an electrolyte injection hole formed on at least one of the can and cap; and a safety member mounted to tightly close the electrolyte injection hole.

Also, the present invention provides a secondary battery, including: a can; a cap assembly on an end of the can; an electrolyte injection hole formed on the cap assembly; means for closing the electrolyte injection hole; and a safety member provided on the can, the safety member for reducing pressure inside the can once the pressure inside the can exceeds a predetermined level.

Preferably, the electrolyte injection hole is formed on a negative portion of the cap assembly.

Preferably, the safety member is inserted into and welded on the electrolyte injection hole.

Alternatively, the safety member is disposed on the electrolyte injection hole and is welded on the negative portion.

Preferably, the safety member is made of a material selected from the group consisting of aluminum, nickel, stainless steel, and nickel gilding steel plate.

Preferably, the safety member is designed to be broken by battery pressure of about 10 to 30 kgf/cm².

Alternatively, the safety member is provided with a plurality of grooves.

### BRIEF DESCRIPTION OF DRAWINGS

The present invention will become more fully understood from the detailed description given hereinbelow and the accompanying drawings which are given by way of illustration only, and thus are not limitative of present invention and wherein:

FIG. 1 is a cross sectional view illustrating a secondary battery where a cap assembly according to a preferred embodiment of the present invention is employed;

FIG. 1A is a cross sectional view illustrating a secondary battery including a cap assembly and a can according to another preferred embodiment of the present invention;

FIG. 1B is a cross sectional view illustrating a secondary battery according to another preferred embodiment of the present invention including a cap assembly and a safety member provided on a side portion or surface of the can;

FIG. 1C is a cross sectional view illustrating a secondary battery according to another preferred embodiment of the present invention including a cap assembly and a safety member provided on a bottom portion or surface of the can;

FIG. 1D is a cross sectional view illustrating a secondary battery according to another preferred embodiment of the present invention including a safety member for closing the electrolyte injection hole that is provided on a bottom portion or surface of the can;

FIG. 1E is a cross sectional view illustrating a secondary battery according to another preferred embodiment of the present invention including a safety member on a bottom portion or surface of the can separate from an electrolyte injection hole provided on the bottom portion or surface of the can;

FIG. 1F is a cross sectional view illustrating a secondary battery according to another preferred embodiment of the present invention including a safety member provided on a side portion or surface on the can separate from an electrolyte injection hole provided on the bottom portion or surface on the can;

FIG. 1G is a schematic diagrammatic illustration of a safety plate or safety member for covering an electrolyte injection hole formed on either the cap assembly or the can, as can be employed in the present invention;

FIG. 2 is a plane view illustrating a cap assembly of a secondary battery according to a preferred embodiment of the present invention;

FIG. 3 is a plane view illustrating a conventional cap assembly of a secondary battery; and

FIG. 4 is a plane view illustrating another conventional cap assembly of a secondary battery.

### DESCRIPTION OF THE PREFERRED EMBODIMENTS

The following is the description of the preferred embodiments according to the present invention. In the drawings, like reference numerals have been used to identify like elements in each figure.

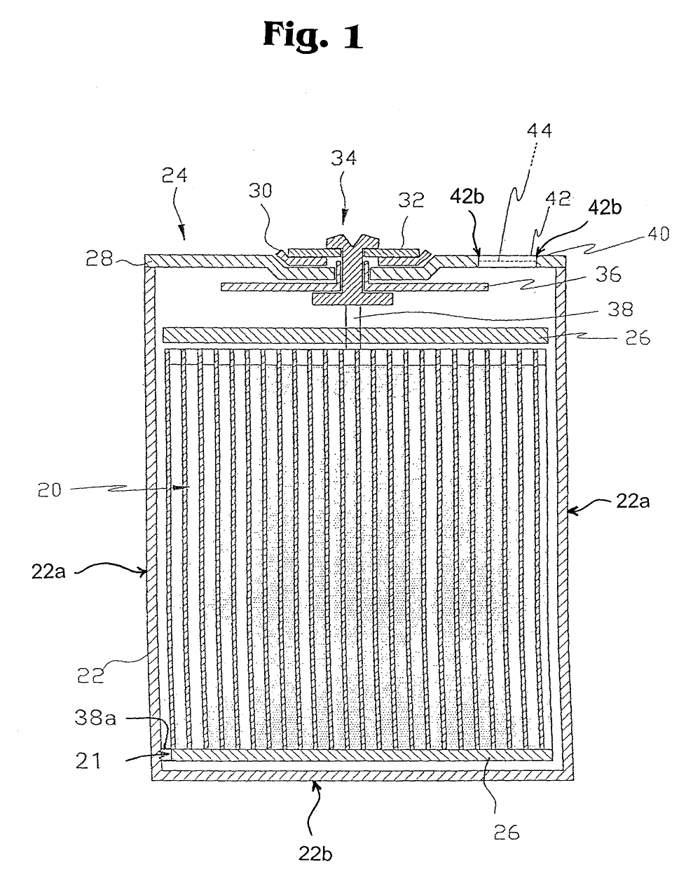

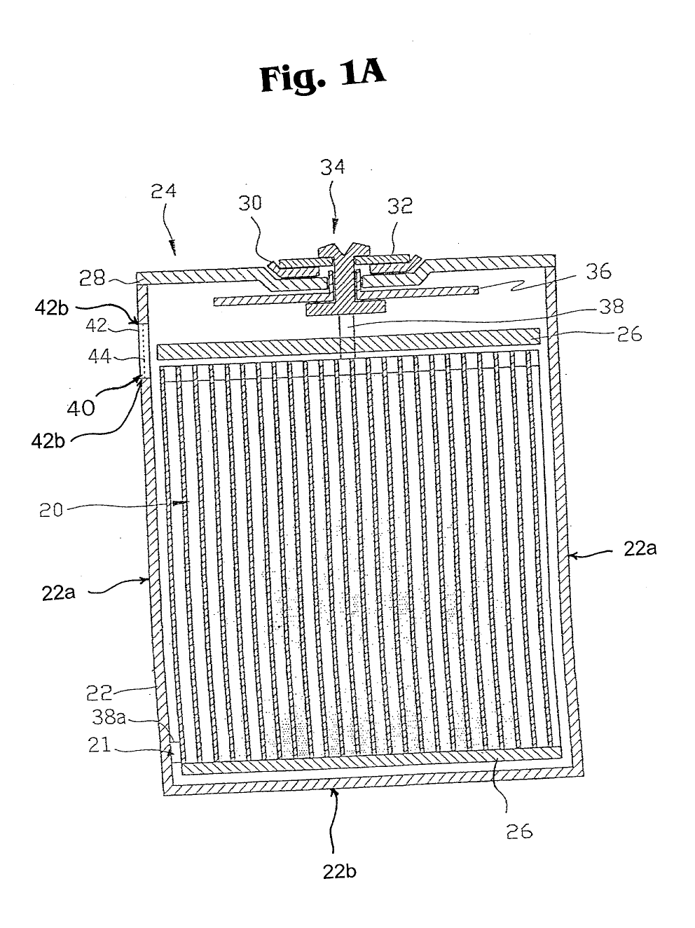

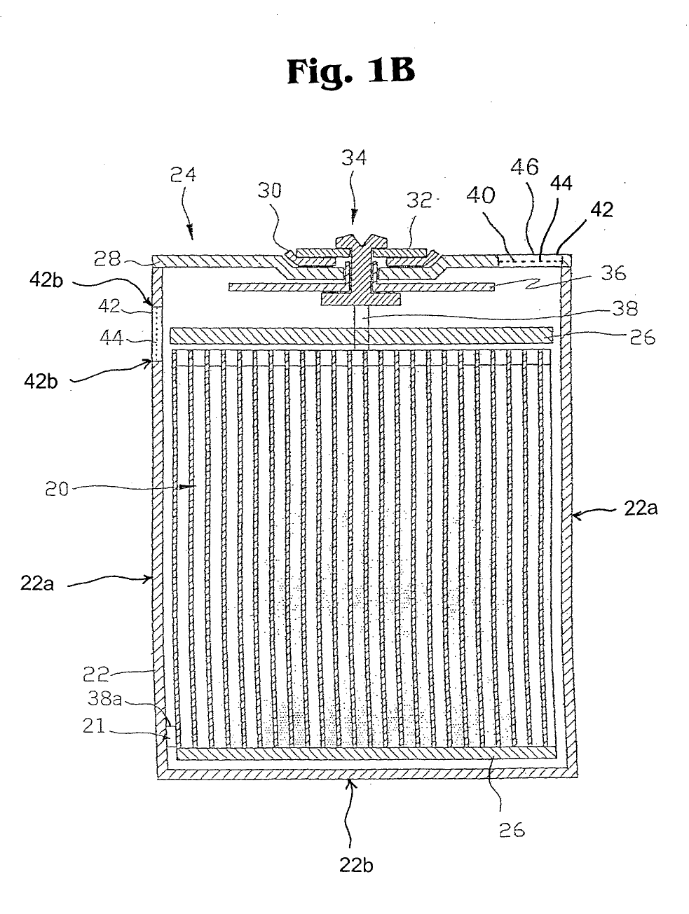

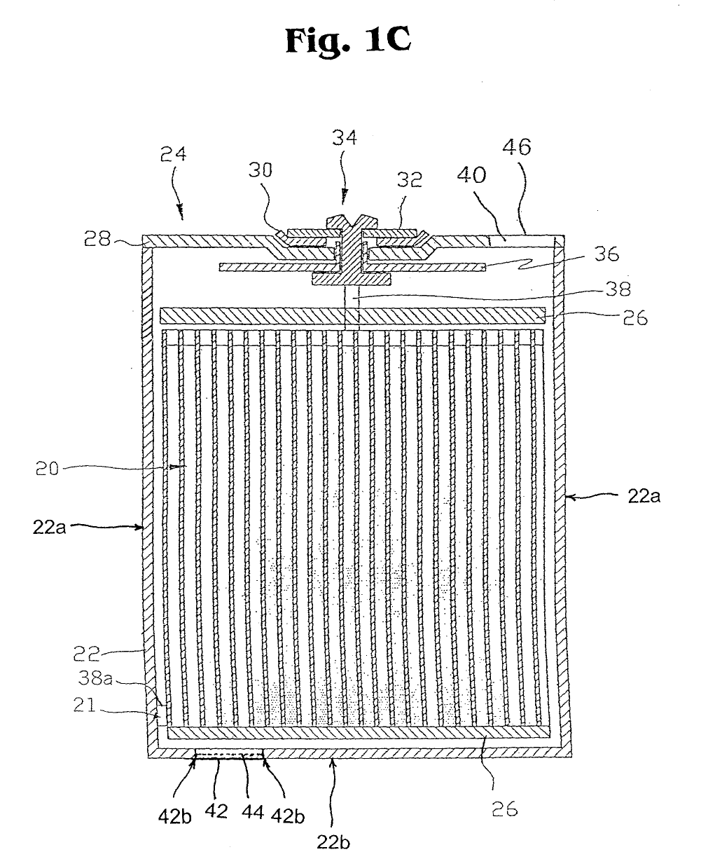

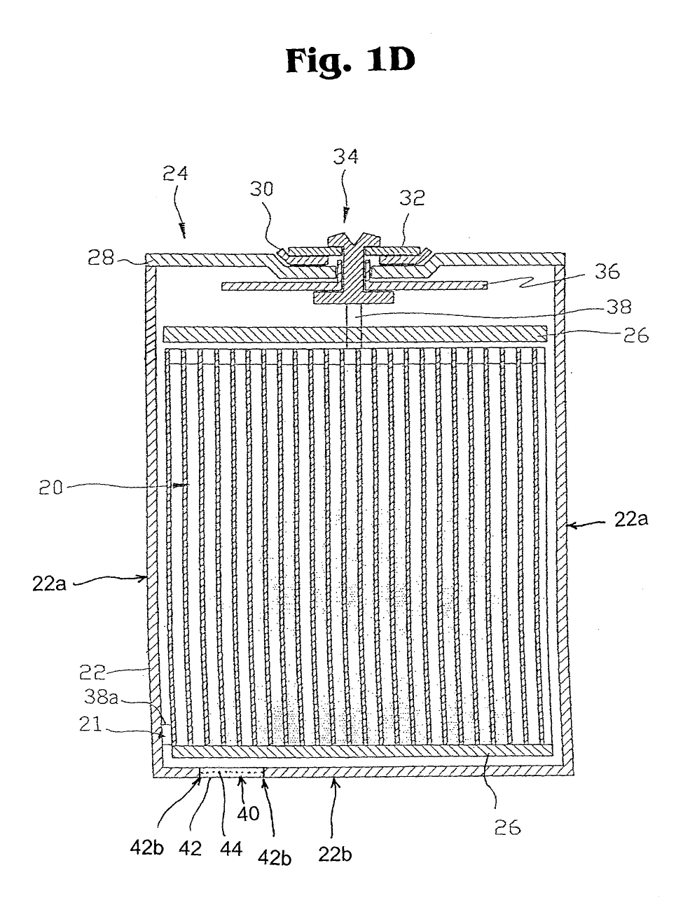

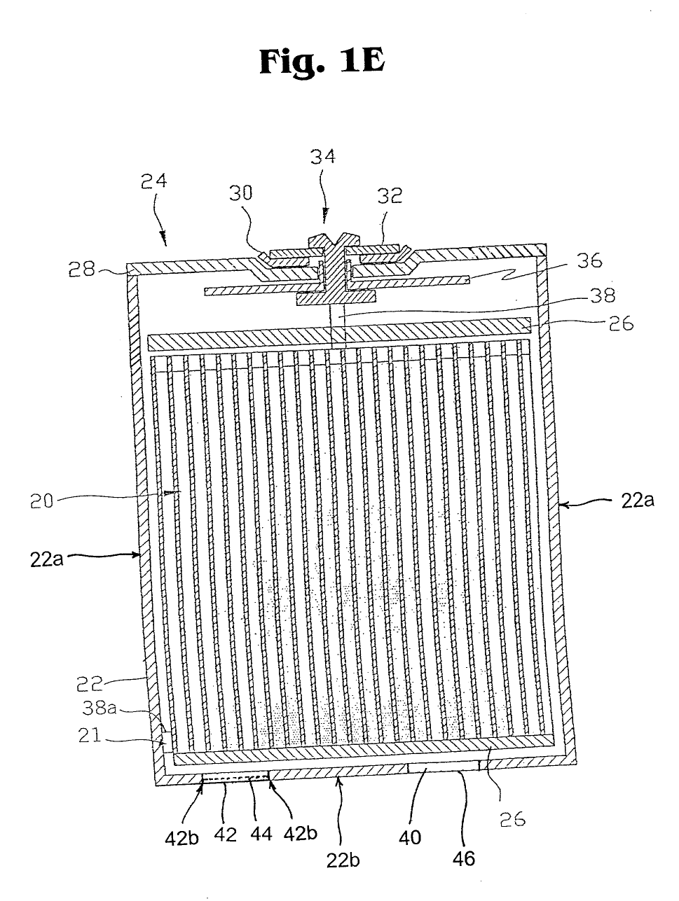

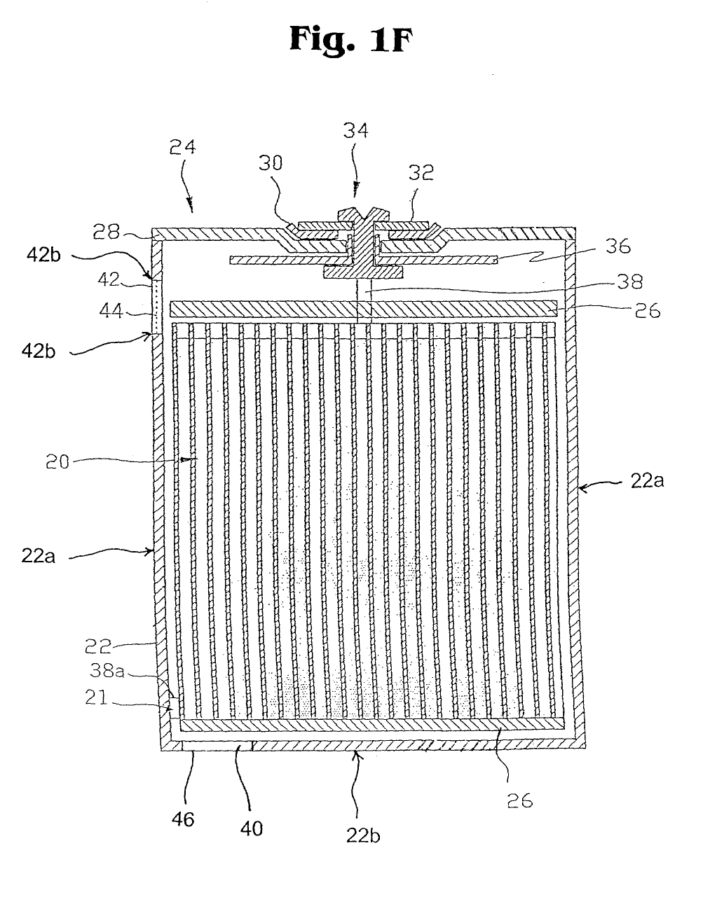

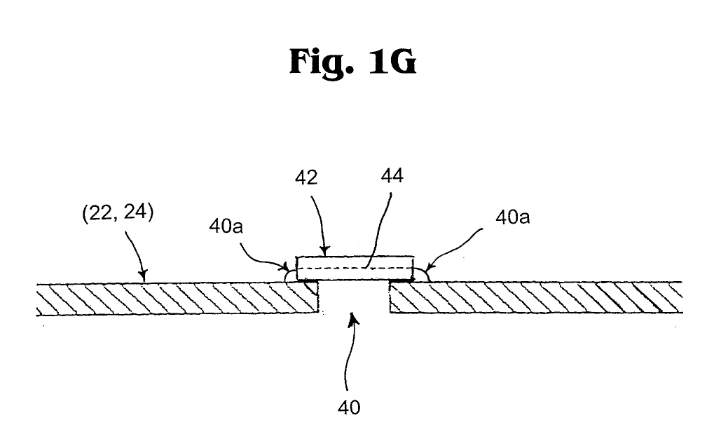

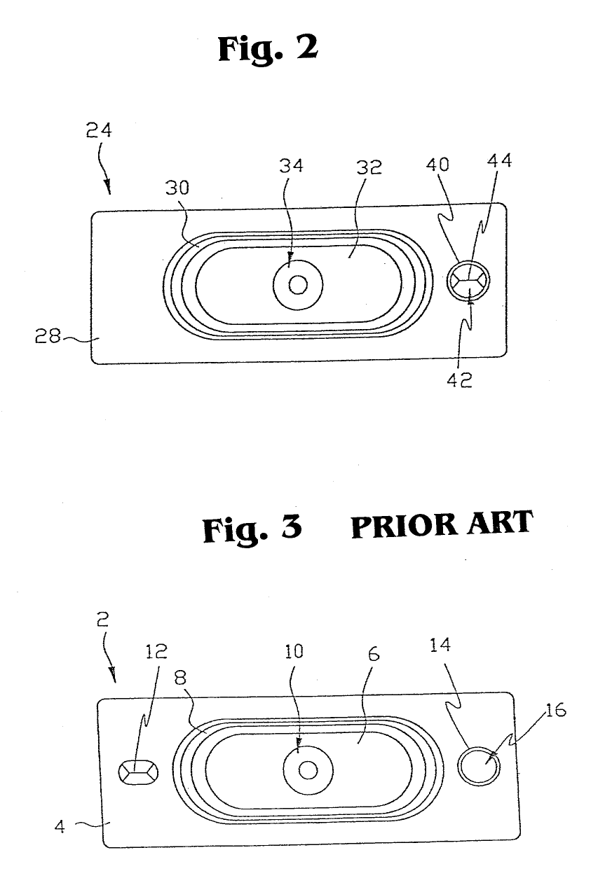

Referring first to FIGS. 1 and 2, and also to FIGS. 1A through 1F, there are respectively shown a sectional views of secondary batteries according to the present invention where a cap assembly 24 and a can 22 are employed, and a plane view of a cap assembly 24 (FIG. 2).

The cap assembly 24 of the present invention is coupled on an upper end of the can 22 in which a roll electrode assembly 20 including a positive electrode, a negative electrode, and a separator, and electrolyte are received. The can includes a side portion or surface 22a, or side portions or surfaces 22a, and a bottom portion or surface 22b. Also, the can 22 contacts the negative electrode 21 by a tap 38a.

Insulating plates 26 are provided at upper and lower ends of the electrode assembly 20 to prevent the electrode assembly 20 from contacting the cap assembly 24 and the can 22.

The cap assembly 24 includes a negative portion 28 which is welded to the upper end of the can 22, a positive portion 32 formed on a central portion of the negative portion 28, and a rivet 34 mounted penetrating a central portion of the negative portion 28 and the positive portion 32. An insulating member 30 is disposed between the negative portion 28 and the positive portion 32. The rivet 34 is used as coupling means for coupling the positive portion 32 with the negative portion 28. An insulating member 36 is disposed between the rivet 34 and the negative portion 28. The rivet 34 is connected to the positive electrode of the electrode assembly through a tap 38. That is, the rivet is used as a terminal for connecting the positive electrode to the positive portion 32. An electrolyte injection hole 40 is formed on the negative portion 28 of the cap assembly 24 or is formed on the can 22 to inject electrolyte into the can 22.

Although, in the embodiments of FIGS. 1, 1B and 1C, an electrolyte injection hole 40 is formed on the negative portion 28 of the cap assembly 24, the location of the electrolyte injection hole 40 is not limited to this structure but can be formed on the can 22, as illustrated in FIGS. 1A, 1D, 1E and 1F.

After the electrolyte is injected into the can 22, the injection hole 40 can be tightly closed by a safety plate or safety member 42, for example. In the embodiments of FIGS. 1, 1A, and 1D the safety plate or safety member 42 can be formed having the same size as that of the injection hole 40 and inserted into and welded on the injection hole 40.

Alternatively, as illustrated in the embodiments of the secondary batteries of FIGS. 1B, 1C, 1E and 1F, the secondary batteries of FIGS. 1B, 1C, 1E and 1F include: a can 22; a cap assembly 24 on an end of the can 22; an electrolyte injection hole 40 formed on the cap assembly 24 in FIGS. 1B and 1C and a electrolyte injection hole 40 formed on the can 22 in FIGS. 1E and 1F; means 46 for closing the electrolyte injection hole 40; and a safety member or safety plate 42 provided on the can 22, the safety member or safety plate 42 being provided on a side surface or portion 22a of the can 22 in FIGS. 1B and 1F and the safety member or safety plate 42 being provided on a bottom surface or portion 22b of the can 22 in FIGS. 1C and 1E, with the safety member 42 for reducing pressure inside the can 22 once the pressure inside the can 22 exceeds a predetermined level. Also, the electrolyte injection hole 40 can be provided on the can 22 separate from the safety plate or safety member 42 on the can 22. In FIG. 1E, for example, the safety plate or safety member 42 is provided on the bottom portion 22b of the can 22 separate from the electrolyte injection hole 40 on the bottom portion 22b of the can 22. Also, in FIG. 1F, for example, the safety plate or safety member 42 is provided on the side portion 22a of the can 22 separate from the electrolyte injection hole 40 on the bottom portion 22b of the can 22.

Further, alternatively, as illustrated in the embodiment of the secondary battery of FIG. 1D, the secondary battery of FIG. 1D includes: a can 22; a cap assembly 24 on an end of the can 22; an electrolyte injection hole 40 on a bottom surface or portion 22b of the can 22; and a safety plate or safety member 42, with the safety plate or safety member 42 being formed of the same size as that of the injection hole 40 and inserted into and welded on the injection hole 40.

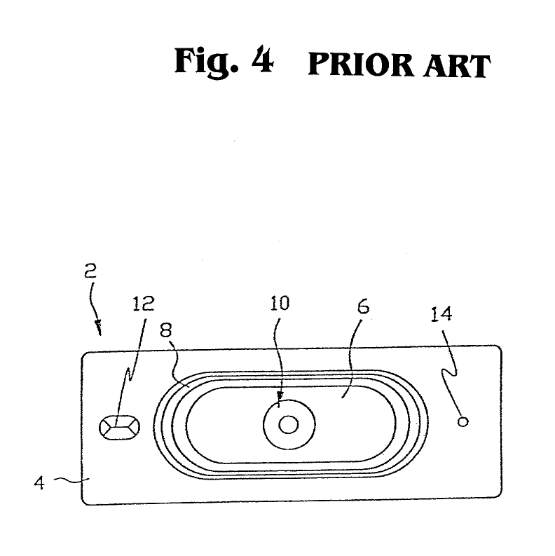

The means 46 for closing the electrolyte injection hole 40 of FIGS. 1B, 1C, 1E and 1F can be a safety plate or safety member 42, such as illustrated in FIGS. 1, 1A, 1B, 1C, 1D, 1E or 1F, with FIG. 1B illustrating an example of a safety plate or safety member 42, as a second safety plate or safety member, for closing the electrolyte injection hole 40. Alternatively, the means 46 can be a plug snugly fit into the electrolyte injection hole 40 and then welded to provide a seal, similar to plug 16 fit into hole 14 of FIG. 3, or the means 46 can include a ball inserted into the injection hole 14 and then welded to provide a seal, similar to the illustration of FIG. 4, for example.

The safety plate 42 is for preventing the explosion of the battery. The safety plate 42 is broken open when the internal pressure of the battery is increased above a predetermined level, thereby preventing the battery from exploding.

More in detail, the safety plate 42 may be made of a material selected from the group consisting of aluminum, nickel, stainless steel, and nickel gilding steel plate.

Preferably, the safety plate 42 is designed to be broken by the internal pressure of about 10 to 30 kgf/cm².

Therefore, when the internal pressure of the battery is increased above a predetermined level by gas generated when the battery is charged and discharged, the safety plate or safety member 42 is removed or cracked, thereby enabling gas from the battery to be exhausted to reduce the internal pressure.

As illustrated in FIG. 1G, for example, the safety plate or safety member 42 in the embodiments of FIGS. 1A through 1F can be formed having larger size than that of the injection hole 40 and is positioned to cover the injection hole 40, with the safety plate 42 being positioned on the injection hole 40 and welded by weld 40a on the negative portion 28 of the cap assembly 24 or on side portion 22a or bottom portion 22b of can 22, respectively. In the case where the safety plate 42 is made of the same material as the negative portion 28 or as the can 22, safety grooves 44 are formed on the safety plate or safety member 42 through a mechanical process, etching or electroforming process. Also, as illustrated in FIGS. 1, and 1A through 1F, the safety plate or safety member 42 can be welded by a weld similar to weld 40a (FIG. 1 G) at a location 42b into an opening in the can 22 or press-fit into an opening of the can 22, for example, with the safety grooves 44 being formed on the safety plate or safety member 42 through a mechanical process, etching or electroforming process, for example. Also, the safety plate or safety member 42 is formed having a thickness or rigidity less than that of the negative portion 28 when the safety plate or safety member 42 is formed in the cap assembly 24.

While this invention has been described in connection with what is presently considered to be the most practical and preferred embodiments, it is to be understood that the invention is not limited to the disclosed embodiments, but, on the contrary is intended to cover various modifications and equivalent arrangements and methods included within the spirit and scope of the appended claims.

What is claimed is:

1. A secondary battery, comprising:
a can;
a cap assembly on an end of the can;
an electrolyte injection hole formed on the cap assembly;
means for closing the electrolyte injection hole; and
a safety member provided on the can, the safety member for reducing pressure inside the can once the pressure inside the can exceeds a predetermined level.

2. The secondary battery of claim 1, further comprised of the safety member being made of a material selected from the group consisting of aluminum, nickel, stainless steel, and nickel gilding steel plate.

3. The secondary battery of claim 2, further comprised of the safety member being designed to be broken by battery pressure of about 10 to 30 kgf/cm².

4. The secondary battery of claim 3, further comprised of the safety member being provided with a plurality of grooves.

5. The secondary battery of claim 4, further comprised of the safety member being designed to be broken by battery pressure of about 10 to 30 kgf/cm².

6. The secondary battery of claim 5, further comprised of the safety member being made of a material selected from the group consisting of aluminum, nickel, stainless steel, and nickel gilding steel plate.

7. The secondary battery of claim 1, further comprised of the safety member being designed to be broken by battery pressure of about 10 to 30 kgf/cm².

8. The secondary battery of claim 1, further comprised of the safety member being provided with a plurality of grooves.

9. The secondary battery of claim 1, further comprising:
a second safety member being inserted into and welded on the electrolyte injection hole.

10. The secondary battery of claim 9, further comprised of the second safety member being designed to be broken by battery pressure of about 10 to 30 kgf/cm².

11. The secondary battery of claim 10, further comprised of the second safety member being provided with a plurality of grooves.

12. The secondary battery of claim 11, further comprised of the second safety member being designed to be broken by battery pressure of about 10 to 30 kgf/cm².

13. The secondary battery of claim 9, further comprised of the second safety member being made of a material selected from the group consisting of aluminum, nickel, stainless steel, and nickel gilding steel plate.

14. The secondary battery of claim 9, further comprised of each safety member being designed to be broken by battery pressure of about 10 to 30 kgf/cm².

15. The secondary battery of claim 9, further comprised of each safety member being provided with a plurality of grooves.

16. The secondary battery of claim 15, further comprised of each safety member being designed to be broken by battery pressure of about 10 to 30 kgf/cm².

17. The secondary battery of claim 1, further comprised of the safety member being provided on a side portion of the can.

18. The secondary battery of claim 17, further comprised of the safety member being designed to be broken by battery pressure of about 10 to 30 kgf/cm².

19. The secondary battery of claim 17, further comprised of the safety member being provided with a plurality of grooves.

20. The secondary battery of claim 19, further comprised of the safety member being designed to be broken by battery pressure of about 10 to 30 kgf/cm².

21. The secondary battery of claim 17, further comprised of the safety member being made of a material selected from the group consisting of aluminum, nickel, stainless steel, and nickel gilding steel plate.

22. The secondary battery of claim 17, further comprising:
a second safety member being inserted into and welded on the electrolyte injection hole.

23. The secondary battery of claim 22, further comprised of the second safety member being designed to be broken by battery pressure of about 10 to 30 kgf/cm².

24. The secondary battery of claim 23, further comprised of the second safety member being provided with a plurality of grooves.

25. The secondary battery of claim 1, further comprised of the safety member being provided on a bottom portion of the can.

26. The secondary battery of claim 25, further comprised of the safety member being designed to be broken by battery pressure of about 10 to 30 kgf/cm².

27. The secondary battery of claim 25, further comprised of the safety member being provided with a plurality of grooves.

28. The secondary battery of claim 27, further comprised of the safety member being designed to be broken by battery pressure of about 10 to 30 kgf/cm².

29. The secondary battery of claim 25, further comprised of the safety member being made of a material selected from the group consisting of aluminum, nickel, stainless steel, and nickel gilding steel plate.

30. The secondary battery of claim 25, further comprising:
a second safety member being inserted into and welded on the electrolyte injection hole.

31. The secondary battery of claim 30, further comprised of the second safety member being designed to be broken by battery pressure of about 10 to 30 kgf/cm².

32. The secondary battery of claim 31, further comprised of the second safety member being provided with a plurality of grooves.

33. A secondary battery, comprising:
a can;
a cap assembly on an end of the can;
an electrolyte injection hole formed on the can;
means for closing the electrolyte injection hole; and
a safety member provided on the can, the safety member for reducing pressure inside the can once the pressure inside the can exceeds a predetermined level.

34. The secondary battery of claim 33, further comprised of the safety member being provided on a side portion of the can.

35. The secondary battery of claim 34, further comprised of the safety member being designed to be broken by battery pressure of about 10 to 30 kgf/cm².

36. The secondary battery of claim 35, further comprised of the safety member being provided with a plurality of grooves.

37. The secondary battery of claim 33, further comprised of the safety member being provided on a bottom portion of the can.

38. The secondary battery of claim 37, further comprised of the safety member being designed to be broken by battery pressure of about 10 to 30 kgf/cm².

39. The secondary battery of claim 38, further comprised of the safety member being provided with a plurality of grooves.

40. The secondary battery of claim 33, further comprised of the electrolyte injection hole on the can being separate from the safety member on the can.
